(19) United States
(12) Patent Application Publication
(10) Pub. No.: US 2008/0090571 A1
(43) Pub. Date: Apr. 17, 2008

(54) Network element and method for making handover

(75) Inventor: Henry KS Kwong, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/709,855

(22) Filed: Feb. 23, 2007

(30) Foreign Application Priority Data
Oct. 17, 2006 (FI) 20065663

(51) Int. Cl. H04Q 7/20

(52) U.S. Cl. 455/436

(57) ABSTRACT

The invention relates to a network element (BSC) for assisting a handover process from a first access network (RAN) to a second access network (GANC), said network element being configured to receive information on neighbouring cells of every transmitter (BTS/Node B/Access point); divide the cells into at least two groups, allocate to every group an identifier (CGI-A, CGI-B, CGI-C, CGI-D) to be used by every transmitter (BTS/Node B/Access point), signal said identifier to an element (MSC) being responsible for a handover process for informing on the identifiers that have correspondence to the second access network, and to be used in a handover request from a core network to the second access network.

### FIELD OF THE INVENTION

The present invention relates to a handover in a communications system, and more particularly to multiple handover identifiers.

### BACKGROUND OF THE INVENTION

The idea of a GAN (Generic Access Network) technology is to provide a user of a mobile station (MS) with a seamless link to a mobile telecommunications network using any IP (Internet Protocol) based network. GAN is specified in the specification 3GPP TS 43.318 and TS 44.318, and the specification is based on a UMA (Unlicenced Mobile Access) technology, which is a limited access via a WLAN (Wireless Local Area Network) or via a Bluetooth network.

For a handover process according to prior art as shown in FIG. 1 from a GERAN (GSM/EDGE radio access network; EDGE, enhanced data rates for global evolution) network to a GAN network, a single identifier CGI-A (CGI, Cell Global Identifier) identifies a network generic access network controller element GANC (UNC, UMA Network Controller in unlicensed mobile access networks). This identification is for the core network elements, such as MSC (Mobile Station Controller). The CGI identifier, which is also called a handover-GANC-CGI identifier (handover-UNC-CGI in UMA specifications), is only used by a core network CN and not by any other elements. According to section C.2.2 of the specification 3GPP TS 43.318 (3GPP, 3rd Generation Partnership Project), “A single GANC represents a single cell, and referred to as GAN cell, for the purpose of handover from GERAN to GAN. This “handover-GANC-CGI” is not visible to the MS. It is only used in the GERAN and CN for identifying a target cell (i.e. target GANC) for handover from GERAN to GAN, and ignored by the GANC, when received during the handover via the A-interface.” The handover-GANC-CGI identifier assigned 1-2 (FIG. 1) to the GANC is configured as the target handover cell in all neighbouring GERAN/UTRAN (UMTS, Universal Mobile Telecommunications System, terrestrial radio access network) cells in an ARFCN/BSIC-to-CGI mapping table (ARFCN, absolute radio frequency number; BSIC, base station identity code).

However, in some BSC (base station controller) implementations, a limitation exists on the maximum number of incoming handover adjacencies, an adjacency being defined as a relationship between a cell and its neighboring cell. As described above, in GAN, each GANC is represented as one cell or CGI, called a handover-GANC-CGI identifier, so within each BSC, a single cell representing the GANC controller exists and which is defined by the handover-GANC-CGI identifier. Consequently, each BSC with this limitation of the maximum number of incoming handover adjacencies can only create adjacencies from the maximum number of its GSM cells into the GAN network technology, e.g. from BTS-1 (Base Transceiver Station) to BTS-L, where “L” is the maximum number of incoming handover adjacencies per cell. A problem arises when an operator wishes to have more than “L” incoming adjacencies per cell.

### BRIEF DISCLOSURE OF THE INVENTION

An object of the present invention is to provide a method and an apparatus for implementing the method so as to solve the above-described problem. The objects of the invention are achieved by a method and an arrangement which are characterized by what is stated in the independent claims. Preferred embodiments of the invention are disclosed in the dependent claims.

The invention is based on the idea of allocating to each GANC (UNC) controller more than one handover-GANC-CGI identifier (handover-UNC-CGI). In such cases, the GANC (UNC) controller will represents more than one single cell.

An advantage of the method and the arrangement of the invention is that by overriding the 3GPP specifications, network operators can easily side-step the above-described problem and no need exists to modify a BSC element or to use many BSC elements in order to use many cells. Another advantage of the method and arrangement of the invention is that this multiple handover-GANC-CGI may also be used for other purposes later.

### BRIEF DESCRIPTION OF THE DRAWINGS

In the following the invention will be described in greater detail by means of preferred embodiments with reference to the attached drawings, in which

FIG. 1 is a block diagram according to prior art;

FIG. 2 is a block diagram according to the invention and its embodiments;

FIG. 3 is a block diagram according to the invention and its embodiments;

FIG. 4 is a signalling diagram according to the invention and its embodiments; and

FIG. 5 is a block diagram according to the invention and its embodiments.

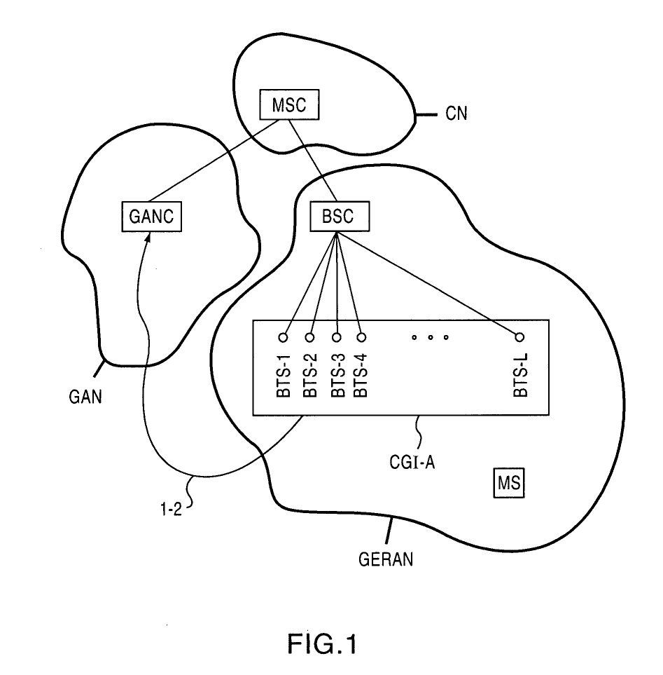

### DETAILED DESCRIPTION OF THE INVENTION

In the following, the invention and its embodiments will mainly be described in connection with two communications systems and with two access networks. They will also be described in connection with two different ways to access a core network. However, the invention and its embodiments are not restricted to the number of communications systems or access networks. Also, regarding the invention, the operation and structure of communications systems and access networks are described only to a degree that will assist in comprehending the invention and its embodiments. The invention and its embodiments are not specific to particular communications systems and access networks, but it will be appreciated that the present invention and its embodiments have application in many system types and may, for example, be applied to a circuit switched domain e.g. in a GSM (Global System for Mobile Communications) digital cellular communication system, in a packet switched domain, e.g. in a UMTS (Universal Mobile Telecommunications System) system, and e.g. in networks according to the IEEE 802.11 standards: WLAN (Wireless Local Area networks), HomeRF (Radio Frequency) or BRAN (Broadband Radio Access Networks) specifications (HIPERLAN1 and 2, HIPERACCESS). The invention and its embodiments can also be applied to ad hoc communications systems, such as an IrDA (Infrared Data Association) network or a Bluetooth network. In other words, the basic principles of the invention can be employed to enable a handover between and/or within any mobile communications systems of the 2^{nd}, 2.5^{th}, 3^{rd}, and 4^{th} generation, such as GSM, GPRS (General Packet Radio Service), TETRA (Terrestrial Trunked Radio), UMTS systems and HSPA (High Speed Packet Access) systems e.g. in WCDMA (Wideband Code Division Multiple Access) technology.

Communications technology using an IP (Internet Protocol) protocol can be e.g. GAN technology (General Access Network), UMA (Unlicensed Mobile Access) technology, the VoIP (Voice over Internet Protocol) technology, peer-to-peer networks technology, and ad hoc networks technology. Different IP protocol versions or combinations thereof can be used.

User equipment that can be used for processing one or more handovers or for assisting in processing one or more handovers according to the invention and its embodiments can be e.g. conventional user equipment that can connect to a wireless local area network. The user equipment can be equipped with a wireless local area network service and/or it may be capable of communicating any other short-range communications media. A wireless local area network WLAN is a network in which a mobile user can connect to the local area network through a wireless connection. This kind of user equipment can be described as two-mode user equipment. The user equipment can comprise means for processing e.g. at least one of the following messages: a short message, an instant message, an e-mail message, a multimedia message, a unified messaging message, a WAP (Wireless Application Protocol) message or an SIP (Session Initiation Protocol) message. The mobile stations can also be mobile stations equipped with e.g. an instant message, an e-mail message, a multimedia message, a unified messaging message, a WAP message or an SIP message service and services like voice calls, wireless Internet browsing, and web broadcasting.

Exemplary user equipment is the user equipment according to 3GPP Rel5 or Rel6 (3rd Generation Partnership Project, Release 5/Release 6), i.e. a terminal that supports a UMTS subscriber identity module USIM (UMTS subscriber identity module) and a Uu interface. This user equipment can be recognized by an SIP URL (Session Initiation Protocol: Uniform Resource Locator) address.

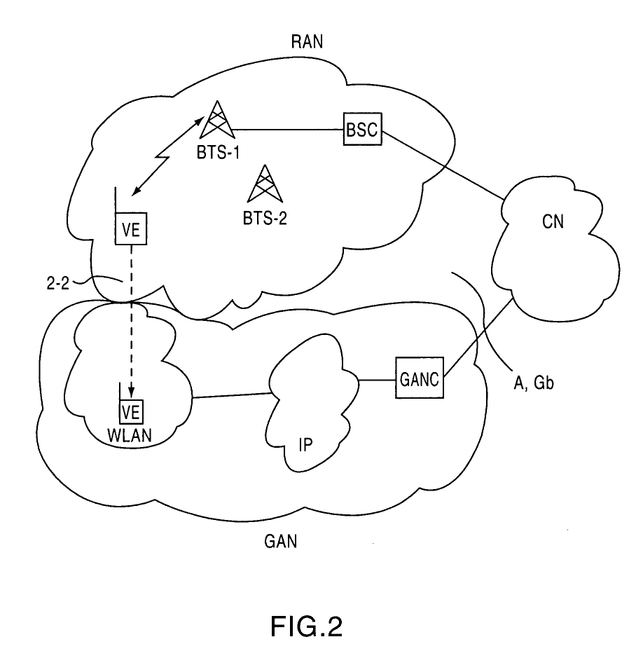

FIG. 2 is a block diagram according to the invention and its embodiments. In the figure a GAN enabled user equipment UE is in communication with one of the base transceiver stations BTS-1 (Base Transceiver Station), BTS-2 of a cellular radio access network RAN. Through a base station controller, the user equipment can communicate with the core mobile network CN. In step 2-2, the user equipment moves from the area of a cellular radio access network to the area of a generic access network (or an unlicensed wireless network, UMAN), like a WiFi network, a WLAN network, or a Bluetooth network. In other words, the user equipment enters e.g. the area of the wireless network and can try to obtain an IP (Internet Protocol) connection. It must be noted that the cellular radio access network can also at least partly cover the area of the generic access network or vice versa. Through an IP access network, which can be e.g. a broadband network, the user equipment communicates with a GAN network controller GANC. In other words, when a mobile station obtains an IP connection, the network communicates with a GAN network controller element GANC (GAN Controller) over an IP protocol. After the user equipment has been identified and authenticated, all traffic that was previously signalled via the cellular radio access network RAN is transferred to pass over the unlicensed mobile access network UMAN to the core mobile network. This means that e.g. all GSM (Global System for Mobile Communications) or GPRS (General Packet Radio Service) traffic is transferred to pass over the IP network. This transfer from the RAN network to the GAN (UMAN) network works seamlessly so that when e.g. a phone call or a data call has been initiated within the area of the RAN network, it continues uninterrupted during the transfer and on the area of the GAN (UMAN) network.

GAN roaming requires that the mobile station functions in mobile telecommunications networks, has an alternative IP connectivity option (such as through WLAN networks), and that the mobile station supports GAN specifications and/or the specifications of the second access network. The interface between the UMA network and the core mobile network can be interface A or Gb.

The BTS elements BTS-1 and BTS-2 or their transmitters can belong to the same or different groups, meaning that they have the same handover-GANC-CGI or different handover-GANC-CGI in their respective handover adjacencies towards the GAN network, correspondingly. If they have the same handover-GANC-CGI, they send the same CGI towards the CN during the handover process. If they have a different handover-GANC-CGI, they send a different CGI towards the CN during the handover process.

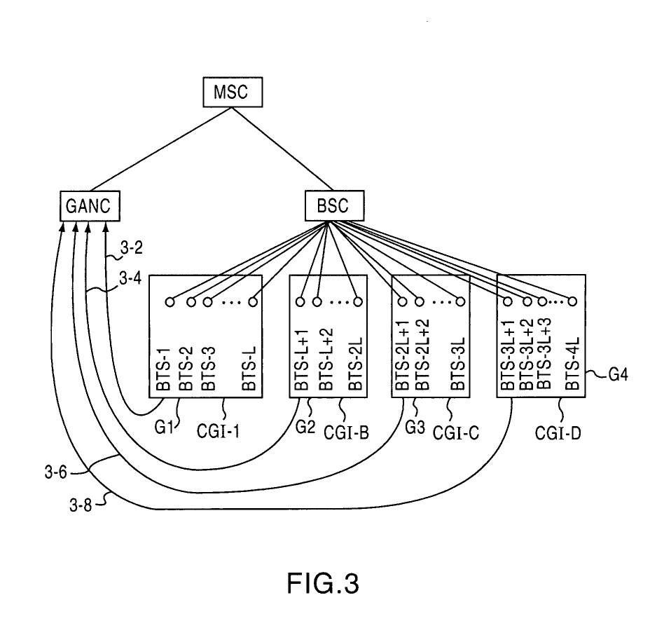

FIG. 3 is a block diagram according to the invention and its embodiments. It shows one BSC (Base Station Controller) element and all BTS elements the BSC element can serve. The limit of the BTS elements one BSC element can serve can be denoted by variable L. For example, if the maximum number of BTSs each BSC can carry is 250, four handover-UNC-CGI identifiers can be used: CGI-A for BTS-1 to BTS-L, CGI-B for BTS-L+1 to BTS-2L, CGI-C for BTS-2L+1 to BTS-3L, and CGI-D for BTS-3L+1 to BTS-4L. The number of identifiers is at least partly obtained from the calculation of the number of base transceiver stations divided by the maximum number of cells, i.e. the ceiling can be e.g. (250/64)=4. In other words, in the BSC, 64 of the cells have an adjacency defined from that particular mapping table NCC/BCC/AFRCN (NCC, Network Colour Code; BCC, Base Station Colour Code; ARFCN, absolute radio frequency number) to CGI-A, 64 defined to CGI-B, 64 to CGI-C and 56 to CGI-C or any other combination that adds to 250 or to the maximum number defined.

Each of these handover-UNC-CGI identifiers can correspond to the same set of NCC/BCC/AFRCN combinations decided for the network to simplify configuration, and all four of them needs to be configured in the relevant MSCs to point to the GANC.

During the handover process into the GAN network, the mobile measurement report from UE to BSC can contain NCC/BCC/AFRCN data, and the BSC can look up the adjacency for that particular GSM cell the call or communication is on. BSC can also find one of the identifiers CGI-A, CGI-B, CGI-C or CGI-D. A handover signalling message containing one of these four CGIs heads toward the MSC finding its way to the GANC.

There are many possible ways to implement the invention and its embodiments. The implementation depends e.g. on the operator. What is required is allocation of extra CGI required for a handover-GANC-CGI purpose to put the CGI into the BSC until the limit for incoming handover runs out and the configuration of the relevant MSCs to point these CGIs to the GANC or UNC. In one implementation, the network element BSC for assisting a handover process from the first access network, like a RAN network, to a second access network, like the GAN network, is configured to receive information on one or more neighbouring cells of one or more or every BTS that wishes to perform a hand over to the second access network. In other words, the BSC can be configured with information on neighbouring cells of transmitters of the first access network. The cells can be divided into at least two groups G1, G2, G3, G4 for being handed over to the second access network. These groups can be divided e.g. into four groups as shown in FIG. 3. Each of these groups can comprise the same or different number of BTSs, transmitters or transceivers, the maximum number being the maximum amount of incoming adjacency the BSC allows each BTS to have. Every BTS in one group can be provided by an identifier CGI-A, CGI-B, CGI-C, CGI-D, and said identifiers corresponding to the second access network can be signalled to the network element, like MSC, being responsible for a handover process. The network element can provide information about the identifier(s) that belong to the second access network for making a handover request from a core network to the second access network possible. The contents of the message need not be changed; only the identifier is changed.

The steps of the invention and its embodiments can be processed in one network element, or they can be processed in more than one network element in one or more communications networks. The user equipment may also participate in these processes. The element(s) can comprise one or more transmitters and/or receivers for processing the signalling of networks of different generations. The element can be named e.g. as BSC, node B or access point. Different steps of the invention and its embodiments may proceed in many different combinations, and the information on the identifiers and their usage and the handover messages can be stored temporarily or permanently in one or more network elements. The division into different groups can be even or uneven. The network element or elements can allocate more than one handover-GANC-CGI identifier to each GANC controller for identifying said network controller element GANC.

In another implementation, NCC/BCC/AFRCN table data from UE to BSC is measured, and the adjacency for the particular RAN cell the communication is on is looked up. To each GANC controller more than one handover-GANC-CGI identifiers can be allocated, so that the GANC controller represents more than one single cell. The handover signalling message containing said one identifier can be made to be heading to a GANC via an MSC. It must be noted that the identifier CGI can belong to GANC. In response to said authentication, the handover process can be made from the cellular radio access network to the unlicensed mobile access network.

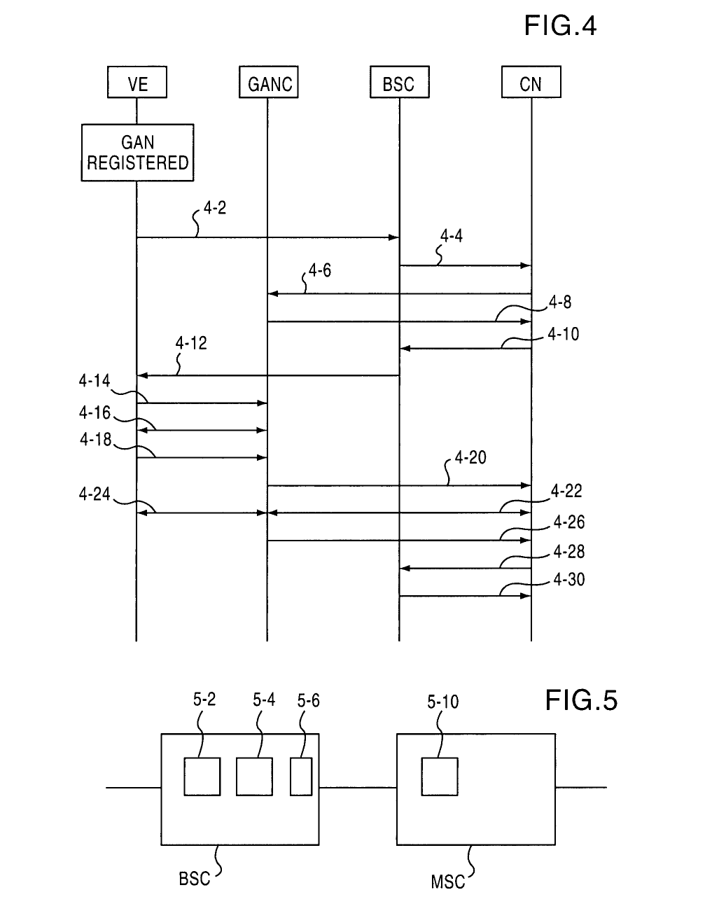

FIG. 4 is a signalling diagram according to the invention and its embodiments. In step 4-2, a measurement report is sent from user equipment, which can be GAN registered, to BSC. A handover is required and this is signalled in step 4-4 to the core network CN. Inside a handover required message, the MSC can receive the CGI identifier of the handover destination cell. Next, the MSC can look through its configuration to decide or to map where to send the next message, i.e. a handover request message 4-6. The message can comprise a CGI with a fixed value for the handover, or one of the N values, where N is the number of groups or a combination thereof. In FIG. 4, it decides that it should send the message to the GANC controller. The core network then makes in step 4-6 a handover request to the GANC controller, asking for a permission for resources to hand over the communication, to hand over the communication from the first access network to the second access network. The network element can provide information about the identifier(s) that belong to the second access network for making a handover request 4-6 from the core network to the second access network possible. GANC can receive the handover request message in step 4-6 and check out its own resource availability. If this is OK, it can send a message “handover request acknowledge” back to MSC 4-8, towards the CGI that sent the handover required message in step 4-4. It obtains information about the incoming handover call from the handover request message in step 4-6 and checks to ensure that everything is correct. In step 4-8, the permission for the handover process is received at the core network. In steps 4-10 and 4-12, a handover command is sent to the user equipment via BSC instructing the user equipment UE to access the core network through the second access network. In steps 4-14, 4-16 and 4-18, a handover access, setup and completion are signalled to GANC correspondingly and between the user equipment and GANC. Next, in steps 4-20 to 4-30, processes for using the resources of the core network via the second access network are completed and the handover is process finished. If GANC is ready for the handover, BSC can send a command to the user equipment for this, and the user equipment receives the command to hand over. Next, the user equipment tries to access the network through GANC. When GANC detects the user equipment, it can establish the handover and complete it. Finally, BSC can release the resources associated with the call.

FIG. 5 is a block diagram according to the invention and its embodiments. It shows BSC and MSC elements. The BSC element can comprise a receiver configured to receive information on neighbouring cells of one or more or every transmitter BTS-1 . . . BTS-4L of the first access network RAN, a processor configured to divide the cells into at least two groups G1, G2, G3, G4 and to allocate to one or more or every group G1, G2, G3, G4 one or more identifiers CGI-A, CGI-B, CGI-C, CGI-D to be used by one or more or every transmitter BTS-1 . . . BTS-4L in that group, and a transmitter configured to signal said identifier CGI-A, CGI-B, CGI-C, CGI-D to an element being responsible for a handover process. The MSC element can also receive information on e.g. one or more transmitters, identifiers, allocations, and groups. The MSC element can also map the information on different cells, allocations, groups and/or identifiers together and provide the GANC element with this information. Alternatively, at least part of the information provided in MSC can be provided in GANC and/or other element(s) of the first network, the second network or the core network to process the handover or assist in processing the handover. At least partly on the basis of said mapping information, the handover process from the cell of the first access network to the cell of the second access network can be processed.

A computer program comprising program code means adapted to perform any neseccary steps when the program is run on a processor can implement the invention and its embodiments. These steps can comprise receiving information on transmitters of neighbouring cells of a first access network, dividing the cells into at least two groups, allocating to every group an identifier to be used by every transmitter in that group, and signalling said identifier to an element being responsible for a handover process from the first access network to the second access network. Also different kind of mapping procedures and transmission of information are possible using one or more computer programs. It also is possible to have a computer program product comprising program code means stored in a computer readable medium, the program code means being adapted to perform any of said steps when the program is run on a computer or on a processor.

A handover system according to the invention and its embodiments can comprise a first network element, like BSC, of a first access network, a second network element, like MSC of a core network, transmitters of neighbouring cells of the first access network divided into at least two groups, and a network controller, like GANC of a second access network. The system can comprise one or more of said elements. All modifications and configurations required for implementing functionality of the embodiments may be performed as routines, which may be implemented as added or updated software routines, application circuits ASIC and/or programmable circuits. Software routines, also called program products, including applets and macros, can be stored in any apparatus-readable data storage medium and they include program instructions to perform particular tasks. Software routines may be downloaded into an apparatus. The apparatus, such as controllers, or corresponding server components, or a user terminal, may be configured as a computer including at least a memory for providing storage area used for arithmetic operation and an operation processor for executing the arithmetic operation. An example of the operation processor includes a central processing unit. The memory may be removable memory detachably connected to the apparatus.

According to the invention and its embodiments, the first access network can be a radio access network and the second access network can be a general access network GAN or an unlicensed mobile access network UMA.

The invention is based on the idea of allocating to each GANC controller more than one handover-GANC-CGI identifier (handover-GANC-CGI). In such cases, the GANC controller represents more than one single cell.

The wireless service can be based on the GAN standard and with the service user equipment can act as an IP phone via e.g. the wireless network WiFi. It is possible that the user can call cheaper at home and use the equipment as a normal mobile phone outside home. The equipment can have a number for the fixed network, and the mobile subscriber number and the equipment can be called by dialling either of the numbers. When conventional mobile phones are continuously in communication with the base station, the GAN and the UMA technologies also enable calls via the Internet using wireless networks like WLAN networks.

An advantage of the method and arrangement of the invention is that they provide an addition and an improvement to the current standard, i.e. to TS 43.318 standard. Another advantage of the method and arrangement of the invention is that by overriding the 3GPP specifications, network operators can easily side-step problems, previously not recognized to exist, like the maximum incoming adjacency limitation described above. The limitation and how to overcome the limitation can thus be solved. This multiple handover-GANC-CGI may also be used for other purposes, e.g. network statistics. Also physical and implementational limitations of BSC itself can be solved by the invention and its embodiments. There is no need to reprogram BSCs or copy BSCs to work e.g. in parallel with the existing BSC. This is very efficient when using GAN and/or UMA networks, in which a large number of cells can be under one BSC element. In other words, the invention and its embodiments can be used when BSC has the capacity to control 4L BTSs, wherein not only BTS-1 to BTS-L can have handover relationship towards the GAN network, but also other BTSs from BTS-L+1 to BTS-4L are able to perform a handover to the GAN network.

It will be obvious to a person skilled in the art that as technology advances, the inventive concept can be implemented in various ways. The invention and its embodiments are not limited to the examples described above but may vary within the scope of the claims.

1. A network element, configured to
receive information on transmitters of neighbouring cells of a first access network;
divide the cells into at least two groups;
allocate to every group an identifier to be used by every transmitter in that group; and
signal said identifier to an element responsible for a handover process from the first access network to a second access network.

2. The network element as claimed in claim 1, wherein said groups contain no more transmitters than a maximum incoming adjacency limit of a base transceiver controller of the first access network.

3. The network element as claimed in claim 1, wherein the cells are divided into four groups.

4. The network element as claimed in claim 1, being configured to allocate to each generic access network controller element (GANC) controller more than one handover-GANC-CGI identifier for identifying said generic access network controller element.

5. A method for making a user equipment handover from a first access network to a second access network, comprising receiving information on neighbouring cells of every transmitter of the first access network;
dividing the cells into at least two groups;
allocating to every group an identifier to be used by every transmitter in that group; and
signalling said identifier for informing about the identifier that has correspondence to the second access network and that is used in a handover request from a core network to the second access network.

6. The method as claimed in claim 5, comprising asking for a permission to hand over communication from the first access network to the second access network;
receiving the permission for a handover process;
sending a handover command to the user equipment instructing the user equipment to access the core network through the second access network; and
completing the handover process.

7. The method as claimed in claim 5, comprising
detecting that the user equipment enters the area of a wireless network and obtaining an IP connection;
identifying the user equipment;
authenticating the user equipment; and
performing the handover so that traffic that was previously signalled via the first access network is transferred to pass over the second access network to the core mobile network.

8. A network element, comprising:
receiving means for receiving information on transmitters of neighbouring cells of a first access network;
processor means for dividing the cells into at least two groups and for allocating to every group an identifier to be used by every transmitter in that group; and
transmitting means for transmitting said identifier to an element being responsible for a handover process from the first access network to a second access network.

9. A network element, comprising:
a receiver configured to receive information on transmitters of neighbouring cells of a first access network;
a processor configured to divide the cells into at least two groups and to allocate to every group an identifier to be used by every transmitter in that group; and
a transmitter configured to transmit said identifier to an element responsible for a handover process from the first access network to a second access network.

10. A network element, comprising:
first receiving means for receiving information on an identifier allocated to transmitters of a group, comprising neighbouring cells of a first access network;
second receiving means for receiving information on one or more cells of a second access network;
mapping means for mapping said identifier to said information on said one or more cells of the second access network; and
transmitting means for transmitting said mapping result to a network controller element of the second access network.

11. The network element as claimed in claim 10, wherein at least one of the first or the second receiving means receive information at predetermined time intervals.

12. The network element as claimed in claim 10, wherein at least one of the first or the second receiving means receive information during a handover request.

13. A computer program embodied on a computer readable medium, the computer program comprising program code for controlling a processor to execute a method comprising:
receiving information on neighbouring cells of every transmitter of the first access network;
dividing the cells into at least two groups;
allocating to every group an identifier to be used by every transmitter in that group; and
signalling said identifier for informing about the identifier that has correspondence to the second access network and that is used in a handover request from a core network to the second access network.

14. A handover system, comprising:
a first network element of a first access network, the network element being configured to receive information on transmitters of neighbouring cells of a first access network, divide the cells into at least two groups, allocate to every group an identifier to be used by every transmitter in that group and signal said identifier to an element responsible for a handover process from the first access network to a second access network;
a second network element of a core network, the second network element comprising receiving means for receiving information on transmitters of neighbouring cells of a first access network, processor means for dividing the cells into at least two groups and for allocating to every group an identifier to be used by every transmitter in that group and transmitting means for transmitting said identifier to an element being responsible for a handover process from the first access network to a second access network;
transmitters of neighbouring cells of the first access network divided into at least two groups; and
a network controller of a second access network.
